(19) United States
(12) Patent Application Publication
(10) Pub. No.: US 2024/0173103 A1
(43) Pub. Date: May 30, 2024

(54) REMOVABLE ORTHODONTIC APPLIANCE FOR FACILITATING ORTHODONTIC TREATMENTS

(71) Applicant: Richard Palmer, Jacksonville, FL (US)

(72) Inventor: Richard Palmer, Jacksonville, FL (US)

(21) Appl. No.: 18/518,888

(22) Filed: Nov. 24, 2023

Related U.S. Application Data
(60) Provisional application No. 63/427,915, filed on Nov. 25, 2022.

(51) Int. Cl. A61C 7/14; A61C 5/70

(52) U.S. Cl. CPC A61C 7/14; A61C 5/70

(57) ABSTRACT

A removable orthodontic appliance for facilitating orthodontic treatments includes a dental brace. Further, the dental brace is configured to be removably attached to teeth of one of an upper jaw and a lower jaw of a user. Further, the dental brace corresponds to a dental arch of the teeth of one of the upper jaw and the lower jaw. Further, the dental brace includes two dental crowns and dental attachments. Further, the two dental crowns are configured to be removably inserted on two molar teeth of one of the upper jaw and the lower jaw for holding the dental brace to one of the upper jaw and the lower jaw. Further, the dental attachments are configured to be removably secured to the teeth based on the removably inserting of the two dental crowns. Further, the dental attachments are interconnected and connected to the two dental crowns.

### CROSS-REFERENCE TO RELATED APPLICATION

This application claims the benefit of U.S. Provisional Patent Application No. 63/427,915, titled “REMOVABLE ORTHODONTIC DENTAL BRACES”, filed 25 Nov. 2022, which is incorporated by reference herein in its entirety.

### FIELD OF THE INVENTION

Generally, the present disclosure relates to the field of orthodontics. More specifically, the present disclosure relates to a removable orthodontic appliance for facilitating orthodontic treatments.

### BACKGROUND OF THE INVENTION

The field of orthodontics is technologically important to several industries, business organizations, and/or individuals.

Existing dental braces are deficient with regard to several aspects. For instance, current braces are made up of multiple separate components and require a professional (dentist, doctor, etc.) to put and/or remove them from the mouth of a patient. Furthermore, current braces usually take a lot of time to wear. Sometimes, wearing braces for a long time proves painful for a patient and the current braces do not allow the patient to remove the braces. Further, current braces require a dental professional to put the braces in and have the braces removed. Further, current braces require the dental professional to make adjustments after a few months. As a result, different braces are needed that can be easily put and removed from the mouth of the patient by the patient.

Therefore, there is a need for a removable orthodontic appliance for facilitating orthodontic treatments that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a removable orthodontic appliance for facilitating orthodontic treatments, in accordance with some embodiments. Further, the removable orthodontic appliance may include at least one dental brace. Further, the at least one dental brace may be configured to be removably attached to teeth of at least one of an upper jaw and a lower jaw of at least one user. Further, the at least one dental brace corresponds to a dental arch of the teeth of at least one of the upper jaw and the lower jaw. Further, each of the at least one dental brace may include at least two dental crowns and a plurality of dental attachments. Further, the at least two dental crowns may be configured to be removably inserted on at least two molar teeth of at least one of the upper jaw and the lower jaw for holding each of the at least one dental brace to at least one of the upper jaw and the lower jaw. Further, the at least two molar teeth may be oppositely located in at least one of the upper jaw and the lower jaw. Further, the plurality of dental attachments may be configured to be removably secured to a plurality of teeth of at least one of the upper jaw and the lower jaw based on the removably inserting of the at least two dental crowns. Further, the plurality of dental attachments may be interconnected. Further, the plurality of dental attachments may be connected to the at least two dental crowns.

Further disclosed herein is a removable orthodontic appliance for facilitating orthodontic treatments, in accordance with some embodiments. Further, the removable orthodontic appliance may include at least one dental brace. Further, the at least one dental brace may be configured to be removably attached to teeth of at least one of an upper jaw and a lower jaw of at least one user. Further, the at least one dental brace corresponds to a dental arch of the teeth of at least one of the upper jaw and the lower jaw. Further, each of the at least one dental brace may include at least two dental crowns, a plurality of dental attachments, and at least one connecting element. Further, the at least two dental crowns may be configured to be removably inserted on at least two molar teeth of at least one of the upper jaw and the lower jaw for holding each of the at least one dental brace to at least one of the upper jaw and the lower jaw. Further, the at least two molar teeth may be oppositely located in at least one of the upper jaw and the lower jaw. Further, the plurality of dental attachments may be configured to be removably secured to a plurality of teeth of at least one of the upper jaw and the lower jaw based on the removably inserting of the at least two dental crowns. Further, the plurality of dental attachments may be interconnected. Further, the plurality of dental attachments may be connected to the at least two dental crowns. Further, the at least one connecting element may be configured for interconnecting the plurality of dental attachments. Further, the at least one connecting element may be configured for connecting the plurality of dental attachments to the at least two dental crowns.

Further disclosed herein is a removable orthodontic appliance for facilitating orthodontic treatments, in accordance with some embodiments. Further, the removable orthodontic appliance may include at least one dental brace. Further, the at least one dental brace may be configured to be removably attached to teeth of at least one of an upper jaw and a lower jaw of at least one user. Further, the at least one dental brace corresponds to a dental arch of the teeth of at least one of the upper jaw and the lower jaw. Further, each of the at least one dental brace may include at least two dental crowns, a plurality of dental attachments, and at least one connecting element. Further, the at least two dental crowns may be configured to be removably inserted on at least two molar teeth of at least one of the upper jaw and the lower jaw for holding each of the at least one dental brace to at least one of the upper jaw and the lower jaw. Further, the at least two molar teeth may be oppositely located in at least one of the upper jaw and the lower jaw. Further, the plurality of dental attachments may be configured to be removably secured to a plurality of teeth of at least one of the upper jaw and the lower jaw based on the removably inserting of the at least two dental crowns. Further, the plurality of dental attachments may be interconnected. Further, the plurality of dental attachments may be connected to the at least two dental crowns. Further, at least one of the plurality of dental attachments may include at least one dental plate. Further, the at least one dental plate may be configured to be removably secured to at least one of the interior side and the exterior side of at least one tooth of the plurality of teeth. Further, the at least one connecting element may be configured for interconnecting the plurality of dental attachments. Further, the at least one connecting element may be configured for connecting the plurality of dental attachments to the at least two dental crowns.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a left side perspective view of a removable orthodontic appliance 100 for facilitating orthodontic treatments, in accordance with some embodiments.

FIG. 2 is a right side perspective view of the removable orthodontic appliance 100, in accordance with some embodiments.

FIG. 3 is a bottom view of a removable orthodontic appliance 300 for facilitating orthodontic treatments, in accordance with some embodiments.

FIG. 4 is a bottom view of the removable orthodontic appliance 300 attached to teeth of a jaw 402, in accordance with some embodiments.

FIG. 5 is a front view of a dental plate 314 of the at least one dental plate 310-320, in accordance with some embodiments.

FIG. 6 is a rear view of the dental plate 314 of the at least one dental plate 310-320, in accordance with some embodiments.

FIG. 7 is a top perspective view of a dental crown 304 of the at least two dental crowns (304 and 306), in accordance with some embodiments.

FIG. 8 is a bottom view of the dental crown 304 of the at least two dental crowns (304 and 306), in accordance with some embodiments.

FIG. 9 is a rear view of the dental plate 314 of the at least one dental plate 310-320, in accordance with some embodiments.

FIG. 10 is a bottom view of the removable orthodontic appliance 300 attached to teeth of a jaw 402, in accordance with some embodiments.

FIG. 11 is a rear view of a plurality of dental plates 1102-1108 of a removable dental brace of a removable orthodontic appliance attached to a plurality of teeth 1110-1116, in accordance with some embodiments.

FIG. 12 is left side perspective view of a removable orthodontic appliance 1200 for facilitating orthodontic treatments, in accordance with some embodiments.

FIG. 13 is a right side perspective view of the removable orthodontic appliance 1200, in accordance with some embodiments.

FIG. 14 is a left side perspective view of a removable orthodontic appliance 1400 for facilitating orthodontic treatments, in accordance with some embodiments.

FIG. 15 is a right side perspective view of the removable orthodontic appliance 1400, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a removable orthodontic appliance for facilitating orthodontic treatments, embodiments of the present disclosure are not limited to use only in this context.

### Overview

The present disclosure describes a removable orthodontic appliance for facilitating orthodontic treatments.

Further, the removable orthodontic appliance may include removable orthodontic dental braces. Further, the orthodontic dental braces may include a brace or brace component configured to adjust and correct crowded, malocclusions, and misaligned teeth. Further, the disclosed braces may include wire and brackets that are individual with traditional braces. Further, the brackets may be designed as all one piece including a wired attachment. The brackets and the wire may be connected to one and sometimes two removable dental crowns on both sides of a patient's lower as well as the upper teeth. The disclosed braces may be available in four design options, dual and singular options refer to the placement of the brackets on the teeth. Depending on the patient's issue, lingual brackets may also be joined with the standard design. Further, a third design option of the four design options may include traditional brackets. Further, a fourth design option of the four design options may include series brackets. Further, the series brackets may include rubber bands in the design while the series brackets may be one solid piece without the ability to adjust. The third design option and the fourth design option may be used to treat crowded teeth, overbites, underbites, gap teeth, and open bites. The disclosed braces may be used to replace traditional braces that are attached directly to a patient's teeth. If needed, the patient may receive a series of customized brackets that may shift their teeth in small increments from their original position for improved dental alignment.

Further, the present disclosure describes removable orthodontic dental braces. Further, the removable orthodontic dental braces may include at least two removable dental crowns. Further, the at least two removable dental crowns may be configured for accommodating at least one tooth of a patient. Further, the patient may include an individual, an institution, and an organization that may want to use the removable orthodontic dental braces. Further, the patient may be suffering from at least one dental malformation. Further, the at least one dental malformation may include crowded teeth, overbite, underbite, gap teeth, open bite, and so on. Further, the at least two removable dental crowns may be essentially clamps that may hold the braces in a mouth of the patient.

Further, the removable orthodontic dental braces may be configured to adjust and correct crowded, malocclusions, and misaligned teeth. Further, the removable orthodontic dental braces may include a wire. Further, the removable orthodontic dental crown may include at least two brackets corresponding to the at least two removable dental crowns. Further, the at least two brackets may be individual with traditional braces. Further, the at least two brackets may be designed as all one piece including a wired attachment (or the wire). The at least two brackets and the wire may be connected to one and sometimes two removable dental crowns on both sides of a patient's lower as well as the upper teeth. The removable orthodontic dental braces may be available in four design options, dual and singular options refer to the placement of the brackets on the teeth. Depending on the patient's issue, lingual brackets may also be joined with the standard design. Further, a third design option of the four design options may include traditional brackets. Further, a fourth design option of the four design options may include series brackets. Further, the series brackets may include rubber bands in the design while the series brackets may be one solid piece without the ability to adjust. The third design option and the fourth design option may be used to treat crowded teeth, overbites, underbites, gap teeth, and open bites. Further, each removable dental crown of the at least two removable dental crowns may connect to each bracket of the at least two brackets using traditional designs. Further, the removable orthodontic dental braces may be removable which allows multiple benefits to the patient such as the ability to maintain better hygiene by being able to remove and properly clean the braces, avoiding discomfort while eating by removal, being able to remove when the discomforts of the braces are causing temporary unbearable pain, not having to go to a local dentist to have the braces put in, (for the series design) returning every 6 to 8 weeks to have the braces adjusted or go through the process of having them removed. Further, the removable orthodontic dental braces also optimize a wear time to wear the braces by the patient. Further, the removable orthodontic dental braces may be essentially one piece and not individual instruments connected by the wire. Further, the at least two removable dental crowns fitted for either two or four of the patient's top and bottom molars may be used to connect the braces and allow for removability but maintain the same benefits as conventional braces.

Further, in some embodiments, the removable orthodontic dental crown may be adjustable.

Further, in some embodiments, the removable orthodontic dental crown may include a thin layer of plastic separating the each bracket from the tooth.

Further, in some embodiments, the removable orthodontic dental crown may be adjustable in the series design.

Further, in some embodiments, the removable orthodontic dental braces may not require any rubber bands for force in the series design.

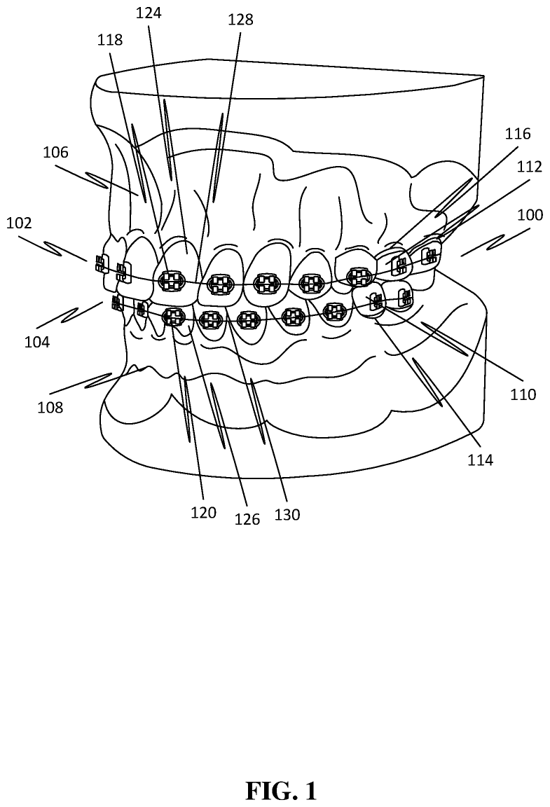

FIG. 1 is a left side perspective view of a removable orthodontic appliance 100 for facilitating orthodontic treatments, in accordance with some embodiments. Further, the removable orthodontic appliance 100 may be manually worn and removed without the need for any tools. Further, the orthodontic treatments may include adjusting and correcting crowded, malocclusions, and misaligned teeth. Further, the orthodontic treatments may be directed towards at least one dental malformation.

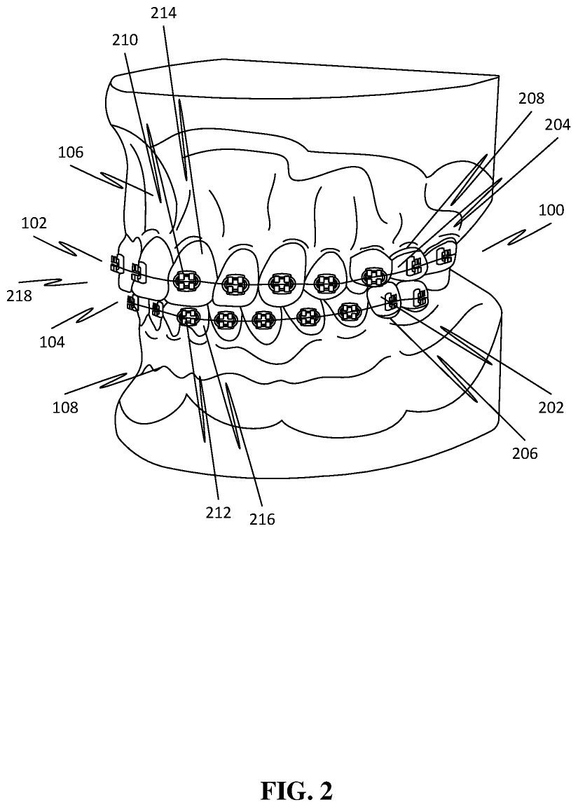

Further, the removable orthodontic appliance 100 may include at least one dental brace 102-104. Further, the at least one dental brace 102-104 may be manually attachable and removable. Further, the at least one dental brace 102-104 may be designed to perform a minor adjustment of the teeth from a current dental arch of the at least one user. Further, the at least one dental brace 102-104 may be configured to be removably attached to teeth of at least one of an upper jaw 106 and a lower jaw 108 of at least one user. Further, the at least one user may include an individual, a patient, etc. Further, the at least one dental brace 102-104 corresponds to a dental arch of the teeth of at least one of the upper jaw 106 and the lower jaw 108. Further, the at least one dental brace 102-104 may be specific to the dental arch of the at least one user. Further, each of the at least one dental brace 102-104 may include at least two dental crowns ((112 and 204) and (110 and 202)) and a plurality of dental attachments ((118-120) and (210-212)), as shown in FIGS. 1 and 2. Further, the at least two dental crowns ((112 and 204) and (110 and 202)) may have a molar tooth shaped recess allowing the at least two dental crowns ((112 and 204) and (110 and 202)) to snugly fit on molar teeth. Further, the plurality of dental attachments ((118-120) and (210-212)) may include brackets. Further, the at least two dental crowns ((112 and 204) and (110 and 202)) and the plurality of dental attachments ((118-120) and (210-212)) may be comprised of at least one material. Further, the at least one material may include metal (such as titanium, stainless steel, gold, chrome, etc.), ceramic, plastic, etc. Further, the at least two dental crowns ((112 and 204) and (110 and 202)) and the plurality of dental attachments ((118-120) and (210-212)) may be constructed as a single piece.

Further, the at least two dental crowns ((112 and 204) and (110 and 202)) may be configured to be removably inserted on at least two molar teeth ((116 and 208) and (114 and 206)), as shown in FIGS. 1 and 2, of at least one of the upper jaw 106 and the lower jaw 108 for holding each of the at least one dental brace 102-104 to at least one of the upper jaw 106 and the lower jaw 108. Further, the at least two molar teeth ((116 and 208) and (114 and 206)) may be oppositely located in at least one of the upper jaw 106 and the lower jaw 108.

Further, the plurality of dental attachments ((118-120) and (210-212)) may be configured to be removably secured to a plurality of teeth ((122-124) and (214-216)), as shown in FIGS. 1 and 2, of at least one of the upper jaw 106 and the lower jaw 108 based on the removably inserting of the at least two dental crowns ((112 and 204) and (110 and 202)). Further, the plurality of dental attachments ((118-120) and (210-212)) may be interconnected. Further, the plurality of dental attachments ((118-120) and (210-212)) may be connected to the at least two dental crowns ((112 and 204) and (110 and 202)).

Further, in some embodiments, each of the at least one dental brace 102-104 may include at least one connecting element (128 and 130). Further, the at least one connecting element (128 and 130) may include a wire, a wired attachment, etc. Further, the at least one connecting element (128 and 130) may be configured for interconnecting the plurality of dental attachments ((118-120) and (210-212)). the plurality of dental attachments ((118-120) and (210-212)) may be attached to a plurality of locations on the at least one connecting element (128 and 130). Further, the at least one connecting element (128 and 130) may be configured for connecting the plurality of dental attachments ((118-120) and (210-212)) to the at least two dental crowns ((112 and 204) and (110 and 202)). Further, two end portions of the at least one connecting element (128 and 130) may be attached to the at least two dental crowns ((112 and 204) and (110 and 202)). Further, each of the at least two dental crowns ((112 and 204) and (110 and 202)) and each of the plurality of dental attachments ((118-120) and (210-212)) may include an attaching mechanism. Further, the attaching mechanism of the at least two dental crowns ((112 and 204) and (110 and 202)) and the plurality of dental attachments ((118-120) and (210-212)) attach to the wire in the plurality of locations.

Further, in some embodiments, the plurality of dental attachments ((118-120) and (210-212)) may include at least one of a plurality of interior attachments and a plurality of exterior attachments. Further, the plurality of interior attachments may be configured to be removably secured to an interior side of the plurality of teeth ((122-124) and (214-216)). Further, the plurality of exterior attachments may be configured to be removably secured to an exterior side of the plurality of teeth ((122-124) and (214-216)).

Further, in some embodiments, at least one of the plurality of dental attachments ((118-120) and (210-212)) may include at least one dental plate. Further, the at least one dental plate may be configured to be removably secured to at least one of the interior side and the exterior side of at least one tooth of the plurality of teeth ((122-124) and (214-216)). Further, the at least one dental plate may be comprised of the at least one material. Further, the at least one material may include metal (such as titanium, stainless steel, gold, chrome, etc.), ceramic, plastic, etc.

Further, in an embodiment, each of the at least one dental plate may include an inner surface and an outer surface. Further, the inner surface abuts at least one of an interior portion and an exterior portion of each of the at least one tooth. Further, the inner surface complements a surface of at least one of the interior portion and the exterior portion.

Further, in some embodiments, the plurality of dental attachments ((118-120) and (210-212)) may be movably interconnected. Further, the plurality of dental attachments ((118-120) and (210-212)) may be movably connected to the at least two dental crowns ((112 and 204) and (110 and 202)).

Further, in some embodiments, the plurality of dental attachments ((118-120) and (210-212)) may be fixedly interconnected. Further, the plurality of dental attachments ((118-120) and (210-212)) may be fixedly connected to the at least two dental crowns ((112 and 204) and (110 and 202)).

Further, in some embodiments, the at least two dental crowns ((112 and 204) and (110 and 202)) may include a plurality of first dental crowns and a plurality of second dental crowns. Further, the plurality of first dental crowns may be configured to be removably inserted on a plurality of first molar teeth present on a first side of at least one of the upper jaw 106 and the lower jaw 108. Further, the plurality of second dental crowns may be configured to be removably inserted on a plurality of second molar teeth present on a second side of at least one of the upper jaw 106 and the lower jaw 108.

Further, in some embodiments, each of the at least two dental crowns ((112 and 204) and (110 and 202)) may include an inner surface and an outer surface. Further, the inner surface abuts a top portion of each of the at least two molar teeth ((116 and 208) and (114 and 206)). Further, the inner surface complements a surface of the top portion.

Further, in some embodiments, at least one of the plurality of dental attachments ((118-120) and (210-212)) may include at least one attachment surface. Further, the at least one attachment surface abuts a surface of at least one of the plurality of teeth ((122-124) and (214-216)).

Further, in an embodiment, the at least one attachment surface may include a layer of at least one material. Further, the at least one material may include plastic, polymer, etc.

FIG. 2 is a right side perspective view of the removable orthodontic appliance 100, in accordance with some embodiments. Further, the plurality of dental attachments ((118-120) and (210-212)) may be a plurality of exterior attachments. Further, the plurality of exterior attachments may be configured to be removably secured to an exterior side 218 of the plurality of teeth ((122-124) and (214-216)).

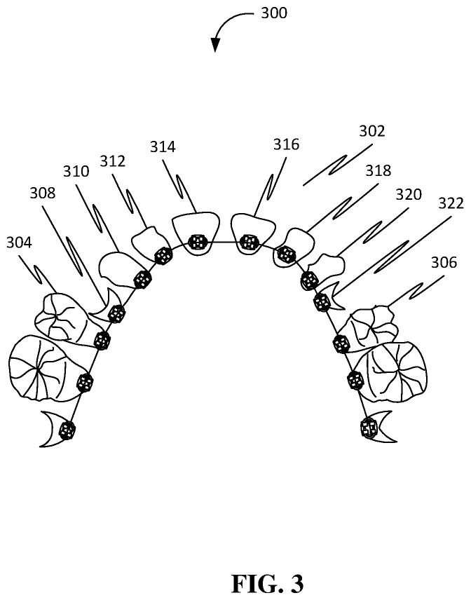

FIG. 3 is a bottom view of a removable orthodontic appliance 300 for facilitating orthodontic treatments, in accordance with some embodiments. Further, the removable orthodontic appliance 300 may include a dental brace 302. Further, the dental brace 302 may include at least two dental crowns (304 and 306) and a plurality of dental attachments 308-322. Further, the plurality of dental attachments 308-322 may be a plurality of interior attachments. Further, the plurality of interior dental attachments 308-322 may include at least one dental plate 310-320.

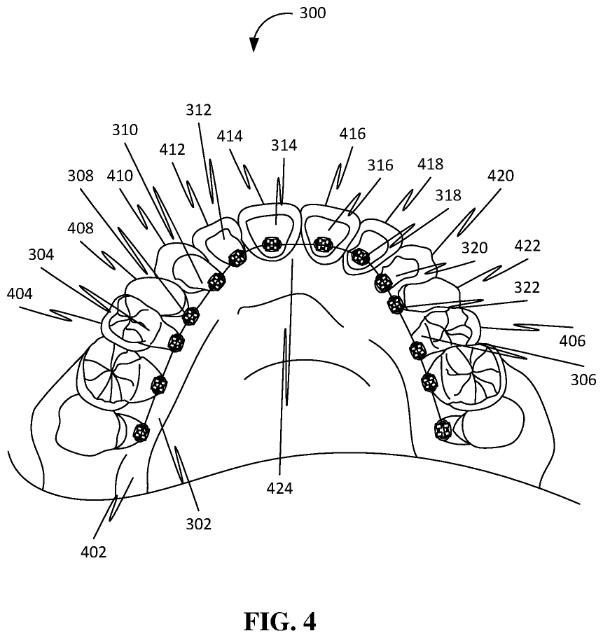

FIG. 4 is a bottom view of the removable orthodontic appliance 300 attached to teeth of a jaw 402, in accordance with some embodiments. Further, the jaw 402 may include an upper jaw, a lower jaw, etc. Further, the at least two dental crowns (304 and 306) may be configured to be removably inserted on at least two molar teeth (404 and 406) of the jaw 402. Further, the plurality of dental attachments 308-322 may be configured to be removably secured to a plurality of teeth 408-422 of the jaw 402. Further, the plurality of dental attachments 308-322 may be a plurality of interior attachments. Further, the plurality of interior attachments may be configured to be removably secured to an interior side 424 of the plurality of teeth 408-422.

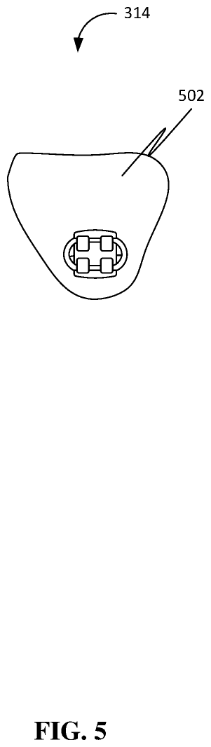

FIG. 5 is a front view of a dental plate 314 of the at least one dental plate 310-320, in accordance with some embodiments. Further, the dental plate 314 may include an outer surface 502.

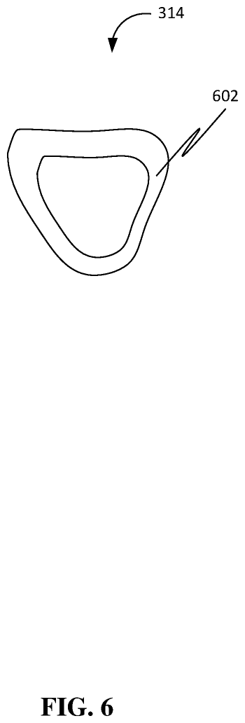

FIG. 6 is a rear view of the dental plate 314 of the at least one dental plate 310-320, in accordance with some embodiments. Further, the dental plate 314 may include an inner surface 602. Further, the inner surface 602 complements a surface of an interior portion of a tooth 414 of the plurality of teeth 408-422. Further, the inner surface 602 defines a recess profiled to complement the interior portion of the tooth 414.

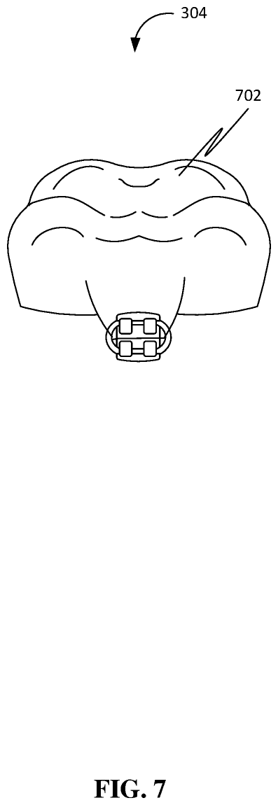

FIG. 7 is a top perspective view of a dental crown 304 of the at least two dental crowns (304 and 306), in accordance with some embodiments. Further, the dental crown 304 may include an outer surface 702. Further, the outer surface 702 may be shaped similarly to a surface of a top portion of a molar tooth 404 of the at least two molar teeth (404 and 406).

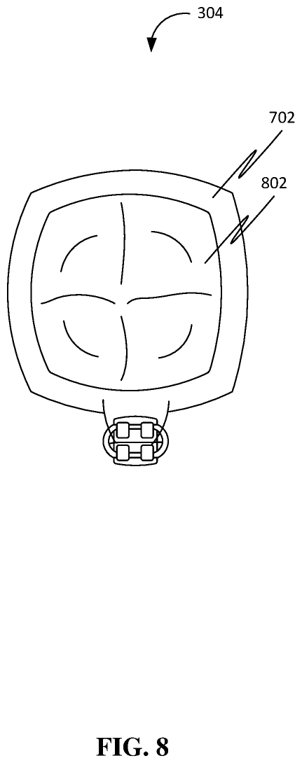

FIG. 8 is a bottom view of the dental crown 304 of the at least two dental crowns (304 and 306), in accordance with some embodiments. Further, the dental crown 304 may include an inner surface 802. Further, the inner surface 802 abuts a top portion of the molar tooth 404. Further, the inner surface 802 complements a surface of the top portion of the molar tooth 404. Further, the inner surface 802 defines a recess profiled to complement the top portion of the molar tooth 404.

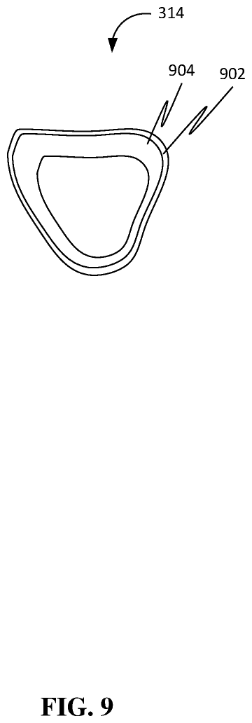

FIG. 9 is a rear view of the dental plate 314 of the at least one dental plate 310-320, in accordance with some embodiments. Further, the dental plate 314 may include an attachment surface 902. Further, the attachment surface 902 may include a layer 904 of at least one material. Further, the at least one material may include plastic, polymer, etc.

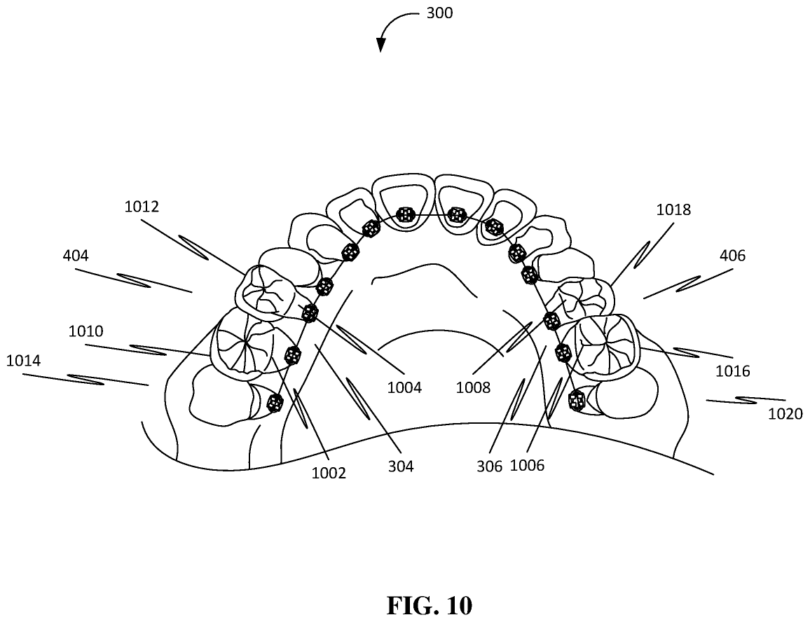

FIG. 10 is a bottom view of the removable orthodontic appliance 300 attached to teeth of a jaw 402, in accordance with some embodiments. Further, the at least two dental crowns (304 and 306) may include a plurality of first dental crowns 1002-1004 and a plurality of second dental crowns 1006-1008. Further, the plurality of first dental crowns 1002-1004 may be configured to be removably inserted on a plurality of first molar teeth 1010-1012 present on a first side 1014 of the jaw 402. Further, the plurality of second dental crowns 1006-1008 may be configured to be removably inserted on a plurality of second molar teeth 1016-1018 present on a second side 1020 of the jaw 402.

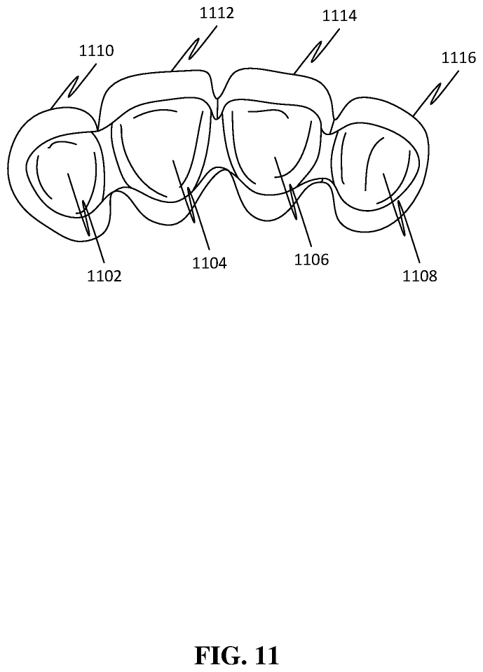

FIG. 11 is a rear view of a plurality of dental plates 1102-1108 of a removable dental brace of a removable orthodontic appliance attached to a plurality of teeth 1110-1116, in accordance with some embodiments. Further, the plurality of dental plates 1102-1108 may be fixedly interconnected. Further, the plurality of dental plates 1102-1108 may be a lingual portion of the dental brace. Further, the plurality of dental plates 1102-1108 may be flat metal plates in a shape of each tooth corresponding to each of the plurality of dental plates 1102-1108. Further, the plurality of dental plates 1102-1108 may be connected to at least two dental crowns. Further, the plurality of dental plates 1102-1108 may solve the issue of dental crowding that involves moving the teeth in different directions.

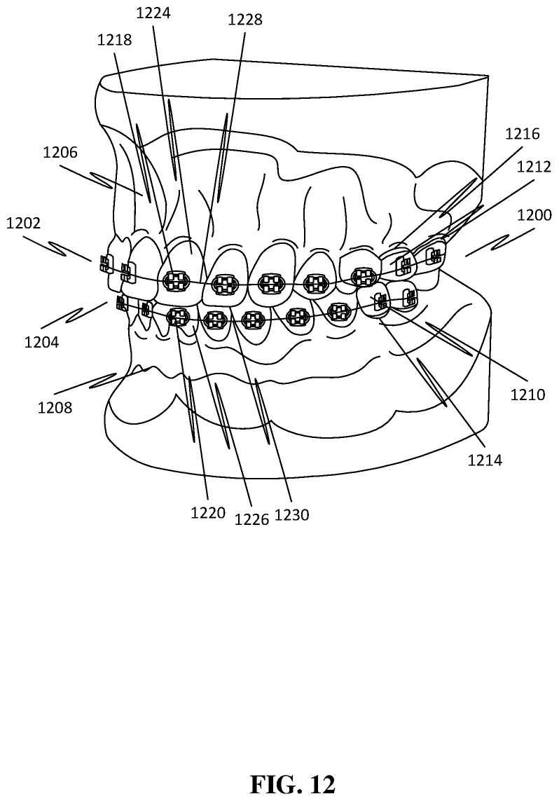

FIG. 12 is left side perspective view of a removable orthodontic appliance 1200 for facilitating orthodontic treatments, in accordance with some embodiments. Further, the removable orthodontic appliance 1200 may include at least one dental brace 1202-1204. Further, the at least one dental brace 1202-1204 may be configured to be removably attached to teeth of at least one of an upper jaw 1206 and a lower jaw 1208 of at least one user. Further, the at least one dental brace 1202-1204 corresponds to a dental arch of the teeth of at least one of the upper jaw 1206 and the lower jaw 1208. Further, each of the at least one dental brace 1202-1204 may include at least two dental crowns ((1212 and 1304) and (1210 and 1302)), a plurality of dental attachments ((1218-1220) and (1310-1312)), and at least one connecting element (1228 and 1230).

Further, the at least two dental crowns ((1212 and 1304) and (1210 and 1302)) may be configured to be removably inserted on at least two molar teeth ((1216 and 1308) and (1214 and 1306)) of at least one of the upper jaw 1206 and the lower jaw 1208 for holding each of the at least one dental brace 1202-1204 to at least one of the upper jaw 1206 and the lower jaw 1208. Further, the at least two molar teeth ((1216 and 1308) and (1214 and 1306)) may be oppositely located in at least one of the upper jaw 1206 and the lower jaw 1208.

Further, the plurality of dental attachments ((1218-1220) and (1310-1312)) may be configured to be removably secured to a plurality of teeth ((1222-1224) and (1314-1316)) of at least one of the upper jaw 1206 and the lower jaw 1208 based on the removably inserting of the at least two dental crowns ((1212 and 1304) and (1210 and 1302)). Further, the plurality of dental attachments ((1218-1220) and (1310-1312)) may be interconnected. Further, the plurality of dental attachments ((1218-1220) and (1310-1312)) may be connected to the at least two dental crowns ((1212 and 1304) and (1210 and 1302)).

Further, the at least one connecting element (1228 and 1230) may be configured for interconnecting the plurality of dental attachments ((1218-1220) and (1310-1312)). Further, the at least one connecting element (1228 and 1230) may be configured for connecting the plurality of dental attachments ((1218-1220) and (1310-1312)) to the at least two dental crowns ((1212 and 1304) and (1210 and 1302)).

Further, in some embodiments, the plurality of dental attachments ((1218-1220) and (1310-1312)) may include at least one of a plurality of interior attachments and a plurality of exterior attachments. Further, the plurality of interior attachments may be configured to be removably secured to an interior side of the plurality of teeth ((1222-1224) and (1314-1316)). Further, the plurality of exterior attachments may be configured to be removably secured to an exterior side of the plurality of teeth ((1222-1224) and (1314-1316)).

Further, in some embodiments, at least one of the plurality of dental attachments ((1218-1220) and (1310-1312)) may include at least one dental plate. Further, the at least one dental plate may be configured to be removably secured to at least one of the interior side and the exterior side of at least one tooth of the plurality of teeth ((1222-1224) and (1314-1316)).

Further, in an embodiment, each of the at least one dental plate may include an inner surface and an outer surface. Further, the inner surface abuts at least one of an interior portion and an exterior portion of each of the at least one tooth. Further, the inner surface complements a surface of at least one of the interior portion and the exterior portion.

Further, in some embodiments, the plurality of dental attachments ((1218-1220) and (1310-1312)) may be movably interconnected. Further, the plurality of dental attachments ((1218-1220) and (1310-1312)) may be movably connected to the at least two dental crowns ((1212 and 1304) and (1210 and 1302)).

Further, in some embodiments, the plurality of dental attachments ((1218-1220) and (1310-1312)) may be fixedly interconnected. Further, the plurality of dental attachments ((1218-1220) and (1310-1312)) may be fixedly connected to the at least two dental crowns ((1212 and 1304) and (1210 and 1302)).

Further, in some embodiments, the at least two dental crowns ((1212 and 1304) and (1210 and 1302)) may include a plurality of first dental crowns and a plurality of second dental crowns. Further, the plurality of first dental crowns may be configured to be removably inserted on a plurality of first molar teeth present on a first side of at least one of the upper jaw 1206 and the lower jaw 1208. Further, the plurality of second dental crowns may be configured to be removably inserted on a plurality of second molar teeth present on a second side of at least one of the upper jaw 1206 and the lower jaw 1208.

Further, in some embodiments, each of the at least two dental crowns ((1212 and 1304) and (1210 and 1302)) may include an inner surface and an outer surface. Further, the inner surface abuts a top portion of each of the at least two molar teeth ((1216 and 1308) and (1214 and 1306)). Further, the inner surface complements a surface of the top portion.

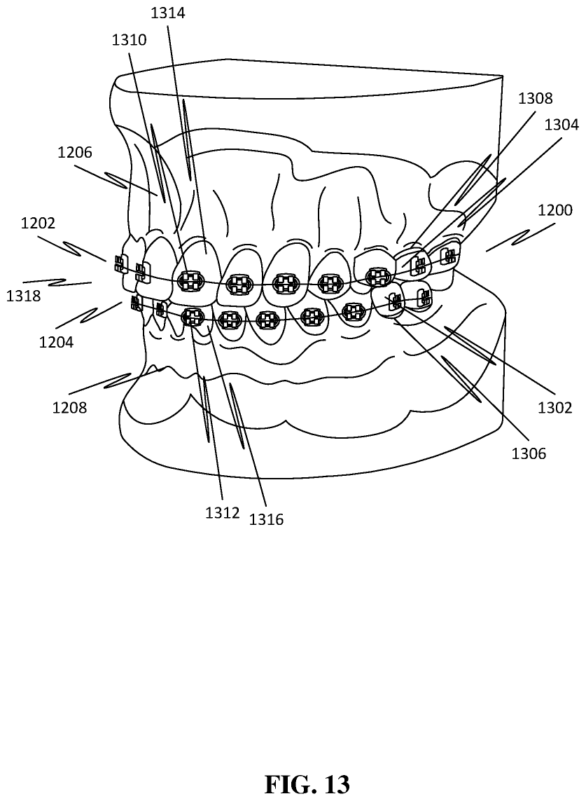

FIG. 13 is a right side perspective view of the removable orthodontic appliance 1200, in accordance with some embodiments. Further, the plurality of dental attachments ((1218-1220) and (1310-1312)) may be a plurality of exterior attachments. Further, the plurality of exterior attachments may be configured to be removably secured to an exterior side 1318 of the plurality of teeth ((1222-1224) and (1314-1316)).

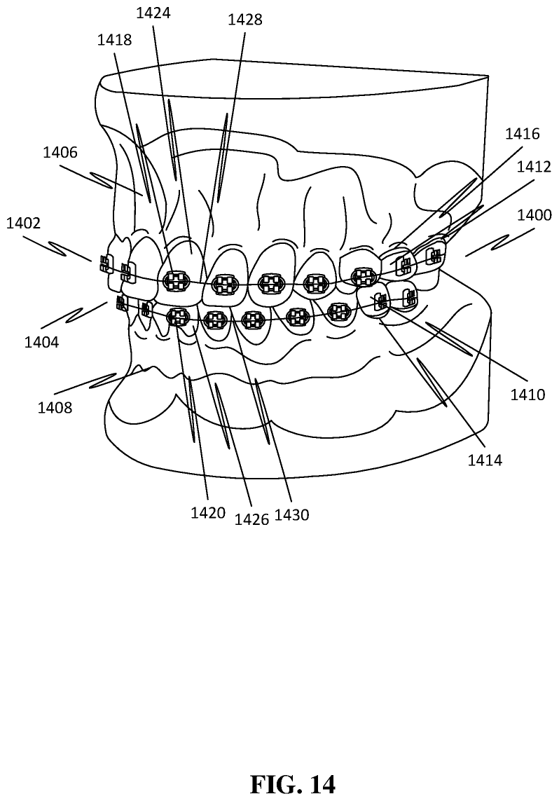

FIG. 14 is a left side perspective view of a removable orthodontic appliance 1400 for facilitating orthodontic treatments, in accordance with some embodiments. Further, the removable orthodontic appliance 1400 may include at least one dental brace 1402-1404. Further, the at least one dental brace 1402-1404 may be configured to be removably attached to teeth of at least one of an upper jaw 1406 and a lower jaw 1408 of at least one user. Further, the at least one dental brace 1402-1404 corresponds to a dental arch of the teeth of at least one of the upper jaw 1406 and the lower jaw 1408. Further, each of the at least one dental brace 1402-1404 may include at least two dental crowns ((1412 and 1504) and (1410 and 1502)), a plurality of dental attachments ((1418-1420) and (1510-1512)), and at least one connecting element (1428 and 1430).

Further, the at least two dental crowns ((1412 and 1504) and (1410 and 1502)) configured to be removably inserted on at least two molar teeth ((1416 and 1508) and (1414 and 1506)) of at least one of the upper jaw 1406 and the lower jaw 1408 for holding each of the at least one dental brace 1402-1404 to at least one of the upper jaw 1406 and the lower jaw 1408. Further, the at least two molar teeth ((1416 and 1508) and (1414 and 1506)) may be oppositely located in at least one of the upper jaw 1406 and the lower jaw 1408.

Further, the plurality of dental attachments ((1418-1420) and (1510-1512)) may be configured to be removably secured to a plurality of teeth ((1422-1424) and (1514-1516)) of at least one of the upper jaw 1406 and the lower jaw 1408 based on the removably inserting of the at least two dental crowns ((1412 and 1504) and (1410 and 1502)). Further, the plurality of dental attachments ((1418-1420) and (1510-1512)) may be interconnected. Further, the plurality of dental attachments ((1418-1420) and (1510-1512)) may be connected to the at least two dental crowns ((1412 and 1504) and (1410 and 1502)). Further, at least one of the plurality of dental attachments ((1418-1420) and (1510-1512)) may include at least one dental plate. Further, the at least one dental plate may be configured to be removably secured to at least one of the interior side and the exterior side of at least one tooth of the plurality of teeth ((1422-1424) and (1514-1516)).

Further, the at least one connecting element (1428 and 1430) may be configured for interconnecting the plurality of dental attachments ((1418-1420) and (1510-1512)). Further, the at least one connecting element (1428 and 1430) may be configured for connecting the plurality of dental attachments ((1418-1420) and (1510-1512)) to the at least two dental crowns ((1412 and 1504) and (1410 and 1502)).

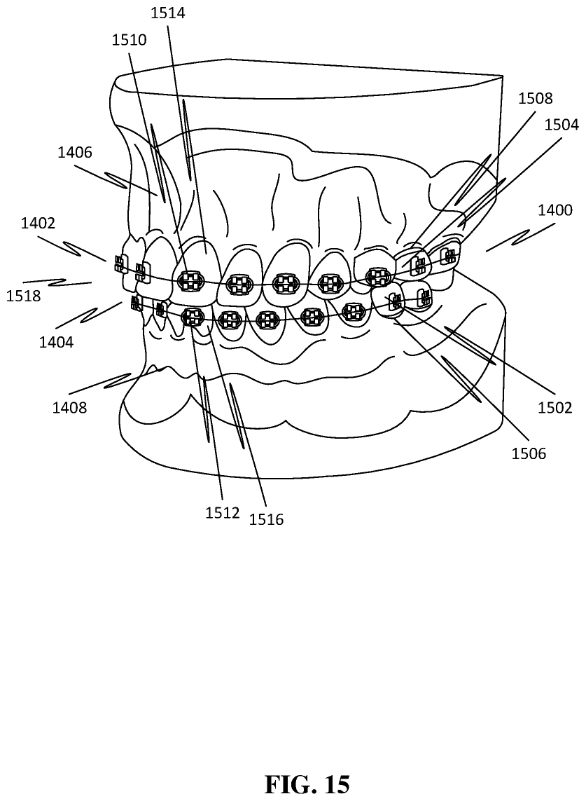

FIG. 15 is a right side perspective view of the removable orthodontic appliance 1400, in accordance with some embodiments. Further, the plurality of dental attachments ((1418-1420) and (1510-1512)) may be a plurality of exterior attachments. Further, the plurality of exterior attachments may be configured to be removably secured to an exterior side 1518 of the plurality of teeth ((1422-1424) and (1514-1516)).

Although the present disclosure has been explained in relation to its preferred embodiment, it is to be understood that many other possible modifications and variations can be made without departing from the spirit and scope of the disclosure.

What is claimed is:

1. A removable orthodontic appliance for facilitating orthodontic treatments, wherein the removable orthodontic appliance comprises at least one dental brace, wherein the at least one dental brace is configured to be removably attached to teeth of at least one of an upper jaw and a lower jaw of at least one user, wherein the at least one dental brace corresponds to a dental arch of the teeth of at least one of the upper jaw and the lower jaw, wherein each of the at least one dental brace comprises:
at least two dental crowns configured to be removably inserted on at least two molar teeth of at least one of the upper jaw and the lower jaw for holding each of the at least one dental brace to at least one of the upper jaw and the lower jaw, wherein the at least two molar teeth are oppositely located in at least one of the upper jaw and the lower jaw; and
a plurality of dental attachments configured to be removably secured to a plurality of teeth of at least one of the upper jaw and the lower jaw based on the removably inserting of the at least two dental crowns, wherein the plurality of dental attachments are interconnected, wherein the plurality of dental attachments are connected to the at least two dental crowns.

2. The removable orthodontic appliance of claim 1, wherein each of the at least one dental brace comprises at least one connecting element, wherein the at least one connecting element is configured for:
interconnecting the plurality of dental attachments; and
connecting the plurality of dental attachments to the at least two dental crowns.

3. The removable orthodontic appliance of claim 1, wherein the plurality of dental attachments comprises at least one of a plurality of interior attachments and a plurality of exterior attachments, wherein the plurality of interior attachments are configured to be removably secured to an interior side of the plurality of teeth, wherein the plurality of exterior attachments are configured to be removably secured to an exterior side of the plurality of teeth.

4. The removable orthodontic appliance of claim 1, wherein at least one of the plurality of dental attachments comprises at least one dental plate, wherein the at least one dental plate is configured to be removably secured to at least one of the interior side and the exterior side of at least one tooth of the plurality of teeth.

5. The removable orthodontic appliance of claim 4, wherein each of the at least one dental plate comprises an inner surface and an outer surface, wherein the inner surface abuts at least one of an interior portion and an exterior portion of each of the at least one tooth, wherein the inner surface complements a surface of at least one of the interior portion and the exterior portion.

6. The removable orthodontic appliance of claim 1, wherein the plurality of dental attachments are movably interconnected, wherein the plurality of dental attachments are movably connected to the at least two dental crowns.

7. The removable orthodontic appliance of claim 1, wherein the plurality of dental attachments are fixedly interconnected, wherein the plurality of dental attachments are fixedly connected to the at least two dental crowns.

8. The removable orthodontic appliance of claim 1, wherein the at least two dental crowns comprise a plurality of first dental crowns and a plurality of second dental crowns, wherein the plurality of first dental crowns are configured to be removably inserted on a plurality of first molar teeth present on a first side of at least one of the upper jaw and the lower jaw, wherein the plurality of second dental crowns are configured to be removably inserted on a plurality of second molar teeth present on a second side of at least one of the upper jaw and the lower jaw.

9. The removable orthodontic appliance of claim 1, wherein each of the at least two dental crowns comprises an inner surface and an outer surface, wherein the inner surface abuts a top portion of each of the at least two molar teeth, wherein the inner surface complements a surface of the top portion.

10. The removable orthodontic appliance of claim 1, wherein at least one of the plurality of dental attachments comprises at least one attachment surface, wherein the at least one attachment surface abuts a surface of at least one of the plurality of teeth.

11. The removable orthodontic appliance of claim 10, wherein the at least one attachment surface comprises a layer of at least one material.

12. A removable orthodontic appliance for facilitating orthodontic treatments, wherein the removable orthodontic appliance comprises at least one dental brace, wherein the at least one dental brace is configured to be removably attached to teeth of at least one of an upper jaw and a lower jaw of at least one user, wherein the at least one dental brace corresponds to a dental arch of the teeth of at least one of the upper jaw and the lower jaw, wherein each of the at least one dental brace comprises:
at least two dental crowns configured to be removably inserted on at least two molar teeth of at least one of the upper jaw and the lower jaw for holding each of the at least one dental brace to at least one of the upper jaw and the lower jaw, wherein the at least two molar teeth are oppositely located in at least one of the upper jaw and the lower jaw;
a plurality of dental attachments configured to be removably secured to a plurality of teeth of at least one of the upper jaw and the lower jaw based on the removably inserting of the at least two dental crowns, wherein the plurality of dental attachments are interconnected, wherein the plurality of dental attachments are connected to the at least two dental crowns; and
at least one connecting element configured for:
interconnecting the plurality of dental attachments; and
connecting the plurality of dental attachments to the at least two dental crowns.

13. The removable orthodontic appliance of claim 12, wherein the plurality of dental attachments comprises at least one of a plurality of interior attachments and a plurality of exterior attachments, wherein the plurality of interior attachments are configured to be removably secured to an interior side of the plurality of teeth, wherein the plurality of exterior attachments are configured to be removably secured to an exterior side of the plurality of teeth.

14. The removable orthodontic appliance of claim 12, wherein at least one of the plurality of dental attachments comprises at least one dental plate, wherein the at least one dental plate is configured to be removably secured to at least one of the interior side and the exterior side of at least one tooth of the plurality of teeth.

15. The removable orthodontic appliance of claim 14, wherein each of the at least one dental plate comprises an inner surface and an outer surface, wherein the inner surface abuts at least one of an interior portion and an exterior portion of each of the at least one tooth, wherein the inner surface complements a surface of at least one of the interior portion and the exterior portion.

16. The removable orthodontic appliance of claim 12, wherein the plurality of dental attachments are movably interconnected, wherein the plurality of dental attachments are movably connected to the at least two dental crowns.

17. The removable orthodontic appliance of claim 12, wherein the plurality of dental attachments are fixedly interconnected, wherein the plurality of dental attachments are fixedly connected to the at least two dental crowns.

18. The removable orthodontic appliance of claim 12, wherein the at least two dental crowns comprise a plurality of first dental crowns and a plurality of second dental crowns, wherein the plurality of first dental crowns are configured to be removably inserted on a plurality of first molar teeth present on a first side of at least one of the upper jaw and the lower jaw, wherein the plurality of second dental crowns are configured to be removably inserted on a plurality of second molar teeth present on a second side of at least one of the upper jaw and the lower jaw.

19. The removable orthodontic appliance of claim 12, wherein each of the at least two dental crowns comprises an inner surface and an outer surface, wherein the inner surface abuts a top portion of each of the at least two molar teeth, wherein the inner surface complements a surface of the top portion.

20. A removable orthodontic appliance for facilitating orthodontic treatments, wherein the removable orthodontic appliance comprises at least one dental brace, wherein the at least one dental brace is configured to be removably attached to teeth of at least one of an upper jaw and a lower jaw of at least one user, wherein the at least one dental brace corresponds to a dental arch of the teeth of at least one of the upper jaw and the lower jaw, wherein each of the at least one dental brace comprises:
at least two dental crowns configured to be removably inserted on at least two molar teeth of at least one of the upper jaw and the lower jaw for holding each of the at least one dental brace to at least one of the upper jaw and the lower jaw, wherein the at least two molar teeth are oppositely located in at least one of the upper jaw and the lower jaw;
a plurality of dental attachments configured to be removably secured to a plurality of teeth of at least one of the upper jaw and the lower jaw based on the removably inserting of the at least two dental crowns, wherein the plurality of dental attachments are interconnected, wherein the plurality of dental attachments are connected to the at least two dental crowns, wherein at least one of the plurality of dental attachments comprises at least one dental plate, wherein the at least one dental plate is configured to be removably secured to at least one of the interior side and the exterior side of at least one tooth of the plurality of teeth; and
at least one connecting element configured for:
interconnecting the plurality of dental attachments; and
connecting the plurality of dental attachments to the at least two dental crowns.
